(19) United States
(12) Patent Application Publication
(10) Pub. No.: US 2008/0188980 A1
(43) Pub. Date: Aug. 7, 2008

(54) VENDING SYSTEM FOR GAS TANK

(76) Inventor: William Home, Taipei City (TW)

Correspondence Address: LEONG C LEI, PMB # 1008, 1867 YGNACIO VALLEY ROAD, WALNUT CREEK, CA, 94598, US

(21) Appl. No.: 11/672,048

(22) Filed: Feb. 7, 2007

(51) Int. Cl. G06F 17/00

(52) U.S. Cl. 700/244

(57) ABSTRACT

An automatic vending system for gas tanks is provided herein. The vending system contains a container assembly having a number of containers. Each container contains a door sensor to sense whether the door to the container is opened, an electronic lock to lock and unlock the door, an availability indicator which is lit when a gas tank is stored in the container, a knob-type detector for identifying the type of knob of the gas tank, and a material detector for identifying the type of the material of the gas task to make sure that a real gas tank is stored. The foregoing components of the containers are connected to a container control module. The container control module in turn is connected to a management module. The management unit is further connected to a remote monitor module so that the containers can be monitored and controlled remotely.

### TECHNICAL FIELD OF THE INVENTION

The present invention generally relates to vending systems and more particularly to a vending system for gas tanks.

### DESCRIPTION OF THE PRIOR ART

Currently there are no automatic vending systems for gas tanks, which are desirable in gas stations and camp sites where people can purchase full gas tanks and return used, empty gas tanks all by themselves.

To have a vending system for gas tanks, there are a number of issues to be addressed. First of all, the gas tanks are best stored in closed containers to prevent them from theft and external impacts. Secondly, the operation of the vending system is best monitored remotely, and the vending system should be connected to a remote cash register in a store's check out counter while the gas tanks are positioned outside the store.

Another challenge to the vending system is that there are different types of the gas tanks for different types of stoves. Usually, different types of tanks cannot be used interchangeably. For example, as shown in FIG. 1, the OPD tanks are those with a triangular knob and a long outlet and, as shown in FIG. 2, the POL tanks are those with a roughly circular knob and a short outlet. In addition, how to prevent a customer from returning a fake gas tank and collecting the deposit also presents a challenge.

### SUMMARY OF THE INVENTION

Accordingly, an automatic vending system for gas tanks is provided herein. The vending system contains a container assembly having a number of containers. Each container contains a door sensor to sense whether the door to the container is opened, an electronic lock to lock and unlock the door, an availability indicator which is lit when a gas tank is stored in the container, a knob-type detector 36 for identifying the type of knob of the gas tank, and a material detector for identifying the type of the material of the gas task to make sure that a real gas tank is stored. The foregoing components of the containers are connected to a container control module. The container control module in turn is connected to a management module. The management unit is further connected to a remote monitor module so that the containers can be monitored and controlled remotely.

Additional container assemblies can be easily and conveniently added to the vending system by cascading the container control modules of the container assemblies. Then, the container control module of the container assembly at an end of the chain is connected to the management module.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 provides a top view of the knob and a profile view of the outlet of an OPD-styled gas tank.

FIG. 2 provides a top view of the knob and a profile view of the outlet of a POL-styled gas tank.

FIG. 3 is a block diagram showing the major functional blocks of the vending system according to the present invention.

FIG. 4 is schematic diagram showing an embodiment of the present invention.

FIG. 5 is a top-view diagram showing the inside of a container of FIG. 4.

FIG. 6 is a profile-view diagram showing the knob-type detector of FIG. 4.

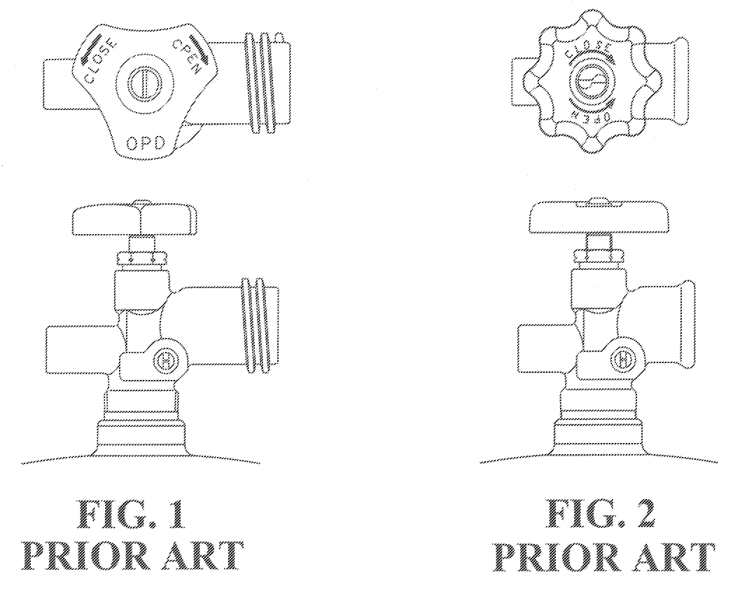

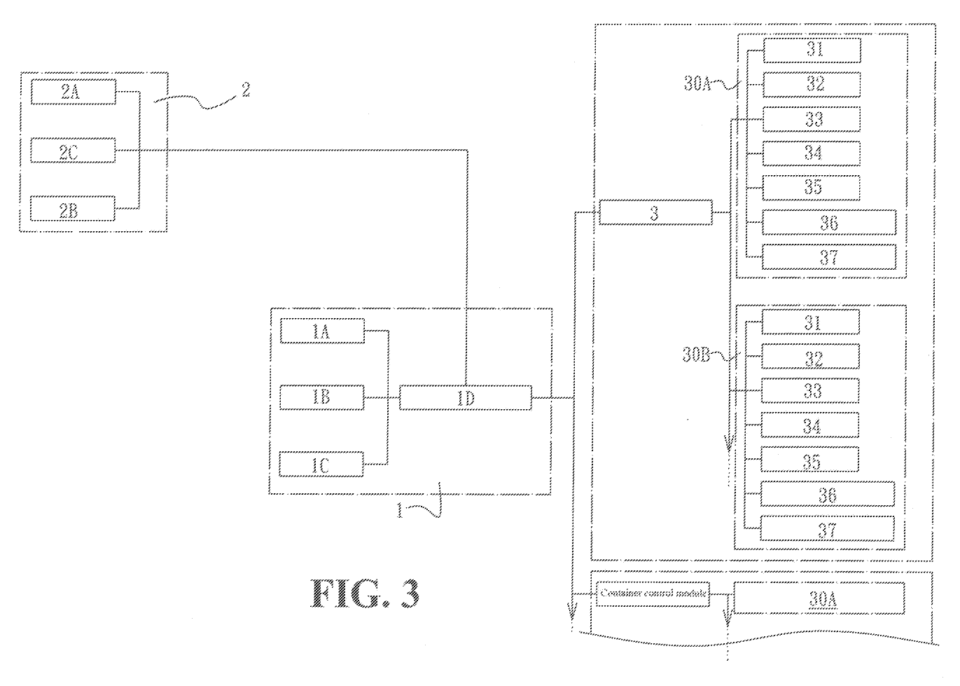

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

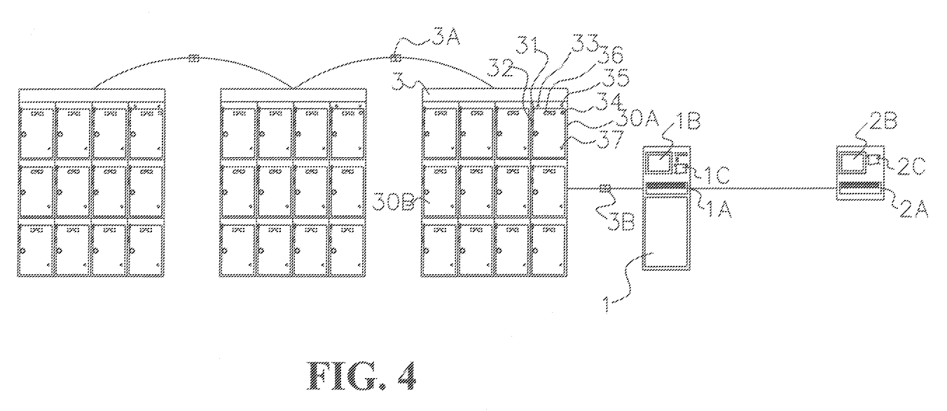

FIG. 3 is a block diagram showing the major functional blocks of the vending system according to the present invention. FIG. 4 is schematic diagram showing an embodiment of the present invention. As illustrated, the vending system contains a container assembly 30 having a number of containers 30A and 30B. Each container 30A or 30B contains a door sensor 31 to sense whether the door to the container 30A or 30B is opened or not, an electronic lock 32 to lock and unlock the door, an open-door indicator 33 which is lit when the door is opened, a lamp 34 to provide illumination in the container 30A or 30B, an availability indicator 35 which is lit when a gas tank is stored in the container 30A or 30B, a knob-type detector 36 for identifying the type of knob of the gas tank, and a material detector 37 for identifying the type of the material of the gas task to guard against fake gas tank. The foregoing components of the containers 30A and 30B are connected to a container control module 3, respectively, over an appropriate two-way connection mechanism to exchange status and control signals. The container control module 3 in turn is connected to a processing unit 1D of a management module 1, also over an appropriate two-way connection mechanism to exchange status and control signals. The management module 1 is usually located close to the container assembly 30 and further contains an input unit 1A, an output unit 1B, and a display unit 1C, all connected to, controlled, and accessed by the processing unit 1D. The management unit 1 is further connected to a remote monitor module 2, again also over an appropriate two-way connection mechanism to exchange status and control signals. The remote monitor module 2 also contains an input unit 2A, a display unit 2B, and an output unit 2C. The remote monitor module 2 is usually located in a distance to the container assembly 30 (such as inside the store) so that the containers 30A and 30B can be monitored and controlled remotely.

The display units 1B and 2B are usually screens for showing various pieces of status information collected by the processing unit 1D of the management module 1 about the containers 30A and 30B. These pieces of status information include, but are not limited to, whether a container 30A or 30B is empty, the type of gas tank in the container 30A or 30B, the address of the container 30A or 30B, whether the door to the container 30A or 30B is opened, and so on. The display units 1B and 2B can also show messages to prompt the customer to enter a password for a specific container 30A or 30B. The input units 1A and 2A are usually keyboards for the customer to specify the type and quantity of the gas tanks to purchase and to enter a password for a specific container 30A or 30B. The output units 1C and 2C are for printing reports for the store owner or receipts for the customers. The processing unit 1D is the brain of the vending system. It is basically a computing device with real-time two-way signal and control links to the input units 1A and 2A, display units 1B and 2B, and output units 1C and 2C.

To use the vending system described above to purchase a full gas tank, a customer follows the instruction shown on the display unit 1B, enters the type and quantity of the gas tank to purchase via the input unit 1A, deposits cash to the management module 1, and retrieves a receipt from the output unit 1C. The display unit 1B will then show the address of the specific container 30A or 30B having the desired gas tank. The management module 1 can provide two purchasing options. With one option, the management module 1 will provide a password that is valid for a period of time so that the customer can open the door to the specific closet 30A or 30B and pick up the gas tank later. With the other option, the processing unit 1D instructs the container control module 3, which in turn triggers the electronic lock 32 of the specific container 30A or 30B to unlock. When the customer opens the door, the door sensor 31 is triggered to turn on the open-door indicator 33 and the lamp 34 to provide lighting in the container 30A or 30B. When the customer removes the gas tank, the knob-type detector 36 and the material detector 37 discover that the gas tank is removed and therefore turn off the availability indicator 35 to indicate that the container 30A or 30B is empty. Please note that all the foregoing status information will be delivered to and collected by the processing unit 1D and shown on the display units 1B and 2B accordingly. By examining the availability indicators 35, the store owner can learn which ones of the containers 30A and 30B are empty and, when the store owner refills an empty container 30A or 30B with a full gas tank, the knob-type detector 36 and the material detector 37 discover that a real gas tank is stored and therefore turn on the availability indicator 35 to indicate that the container 30A or 30B is now occupied.

Additional container assemblies 30 can be easily and conveniently added to the vending system by cascading the container control modules 3 of the container assemblies 30 via an appropriate two-way signal and control cabling mechanism 3A. Then, the container control module 3 of the container assembly 30 at an end of the chain is connected to the management module 1 also via a similar cabling mechanism 3B.

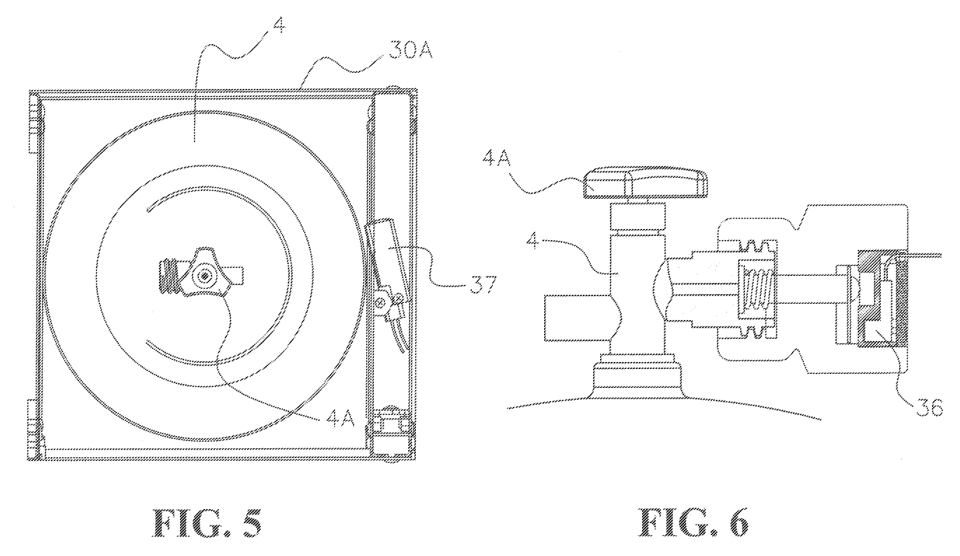

FIG. 5 is a top-view diagram showing the inside of a container 30A, which also applies to the containers 30B. As illustrated, the material detector 37 is fixedly installed inside the container 30A and adjacent to the gas tank 4. FIG. 6 is a profile-view diagram showing the knob-type detector 36, which is also installed inside the container 30A or 30B and adjacent to the outlet between the knob 4A and the tank. The knob-type detector 36 and the material detector 37 operate in accordance with the physics principle that conductors of various materials and shapes would be induced to produce different amounts of charges. As such, the knob-type detector 36 and the material detector 37 are able to derive different electrical signals corresponding to the different types of knobs and different types of materials for the gas tanks, respectively. In this way, the vending system is therefore able to determine whether it is really a gas tank (made of steel) or something else, and whether the knob is of the OPD-styled or the POL-styled.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A vending system for gas tanks comprising:
a first container assembly having a plurality of containers, each having a door sensor to sense whether the door to the container is opened, an electronic lock to lock and unlock the door, an open-door indicator which is lit when the door is opened, a lamp to provide illumination in the container, an availability indicator which is lit when there is a gas tank in the container, a knob-type detector for identifying the type of knob of the gas tank, and a material detector for identifying the type of the material of the gas task to signify that a real gas tank is stored in the container.
a container control module connected to the foregoing components of the containers in the first container assembly via a two-way signal and control link, respectively;
a management module having a processing unit, an input unit, an output unit, and a display unit, the processing unit connected to the container control module, the input unit, the output unit, and the display unit via a two-way signal and control link, respectively; and
a remote monitor module having an input unit, an output unit, and a display unit connected to the management module via a two-way signal and control link, respectively;
wherein the material detector and the knob-type detector are located inside the container and adjacent to the gas tank and the outlet of the gas tank, respectively, so as to detect the type of the gas tank and to make sure a real gas tank is stored in the container.

2. The vending system according to claim 1, further comprising:
a second container assembly having a plurality of containers, each having a door sensor to sense whether the door to the container is opened, an electronic lock to lock and unlock the door, an open-door indicator which is lit when the door is opened, a lamp to provide illumination in the container, an availability indicator which is lit when there is a gas tank in the container, a knob-type detector for identifying the type of knob of the gas tank, and a material detector for identifying the type of the material of the gas task to signify a real gas tank is stored in the container;
a second container control module connected to the foregoing components of the containers in the second container assembly via a two-way signal and control link; and
a two-way signal and control cabling mechanism connecting the second container control module to the first container control module.
